(19) United States
(12) Patent Application Publication
(10) Pub. No.: US 2007/0019639 A1
(43) Pub. Date: Jan. 25, 2007

(54) Method for relaying ip-packets to an external control component of a network node

(75) Inventors: Johannes Bergmann, Bemried (DE); Anton Schmitt, Vaterstetten (DE); Christian Winkler, Munich (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS CORPORATION, Muenchen (DE)

(21) Appl. No.: 10/558,895

(22) PCT Filed: May 27, 2004
(86) PCT No.: PCT/EP04/50948

§ 371 Date: Nov. 30, 2005

(30) Foreign Application Priority Data
May 30, 2003 (DE) 103 24 603.7

(51) Int. Cl. H04L 12/56; H04J 3/12

(52) U.S. Cl. 370/389; 370/522

(57) ABSTRACT

IP packets are received, identified, evaluated and processed at interfaces of a network node in a communications network, which comprises a number of network nodes and which transmits IP packets. An in-band IP signaling packet, which is received at an interface of the network node, is identified at the interface and is characterized by an entry in the protocol field of the header of the IP packet, a one-to-one value, which is assigned to the receiving interface and which differs from the values of the other interfaces is entered in a field of the IP header of the IP packet and the modified packet is sent to the control component.

### CROSS REFERENCE TO RELATED APPLICATIONS

This application is the US National Stage of International Application No. PCT/EP2004/050948, filed May 27, 2004 and claims the benefit thereof. The International Application claims the benefits of German application No. 10324603.7 DE filed May 30, 2003, both of the applications are incorporated by reference herein in their entirety.

### FIELD OF INVENTION

The invention relates to a method for relaying IP packets to an external control component of a network node.

### BACKGROUND OF INVENTION

In future, internet protocol networks, also referred to as IP networks, will transport superior quality services in addition to the standard current internet and best effort services and allow new applications. This will require extensions to the controller of the network nodes of an IP network or the network controller, e.g. to manage network resources or for fast reconfiguration in the event of an error.

In general the alternatives are as follows:
Integrating control components in the network components, network nodes and/or network elements, such as routers, or
Linking control components in the form of external servers to the network components, network nodes or routers to be controlled. This can take place directly, i.e. by means of a connection or line between an external interface of the network component and the nearby control component or via a network connection between the network component and the control component.

The first integrated solution has the advantage that network component information is available to the control component due to the close link with the network component.

In contrast an “add-on” solution is non-proprietary and more flexible, precisely because it is not so closely associated with the internal elements of the network component. Also “add-on” solutions can be based on standard hardware HW and software SW solutions, while network components such as routers are generally based on proprietary HW/SW solutions. “Add-on” control components allow shorter development cycles and cost savings to be achieved. The disadvantage of “add-on” solutions is however that internal network component information is not available.

The problems relating to the second, external, “add-on” server solution are set out below using the example of an admission control AC control component.

One object of an admission control is to receive incoming resource requests, compare these with the resources still available and, if resources are still available, to program a network node or router, e.g. the router at the edge of the network or edge router, to control the data flow. This includes setting so-called functions, such as marking, filtering and policing.

The following two questions thereby arise:
A) How do the resource requests reach the add-on control component or admission control?
B) How can the control component or admission control control and configure the network node and from where does the control component obtain the necessary information about the internal elements of the network component, e.g. the interface at which a packet has been received and the interface to be configured?

There are two variants of a solution to A) in principle:
1) The data path taken by the IP packets is known and the control component or admission control can therefore be addressed directly accordingly. This is referred to as so-called out-band signaling.
2) The signaling protocol follows the path of the data packets and therefore finds the control component or admission control automatically. This is referred to as so-called in-band signaling.

Only signaling according to the variant 2), i.e. in-band signaling, is assumed below.

The standard resource reservation protocol RSVP is an in-band signaling protocol. It resolves the questions set out above, as described under point 2), and implements hop by hop reservation in the network node. The essential point here is that the RSVP entity is implemented in the router itself and can therefore operate in a very closely interleaved fashion with the router and its internal elements.

The process is described schematically using the example of an RSVP-capable network, i.e. a network with RSVP-capable network nodes or routers according to FIG. 1.

FIG. 1 shows a schematic IP network comprising a plurality of network nodes and routers A to H, each having an internal control component AC. The network node A is connected to the network node E on the one hand by means of a series connection comprising the network nodes B, C, D and on the other hand by means of a series connection comprising the network nodes F, G, H. The network nodes B and G, C and H and D and H are also connected together. The connections or connection paths are for example configured as electrical or optical lines, such as two-wire lines, coaxial cables or optical waveguides. A subscriber X is connected at the network node A and a subscriber Y is connected at the network node E.

The subscriber X generates a resource request to the network for a data stream to the subscriber Y. It must thereby be ensured that the resource reservations in the network nodes are also actually made along the subsequent data path. In IP networks this data path is a function of current routing. Therefore in the resource reservation protocol RSVP the resource request is sent to the network with the IP destination address, i.e. the IP address of the subscriber Y. It therefore automatically follows the data path of the subsequent data stream to the subscriber Y. Although these RSVP messages are now not addressed to the RSVP control components AC or RSVP entities, the RSVP control components RSVP or RSVP entities of the network nodes on the path must be notified of them.

These messages are therefore specifically characterized by the defined IP protocol type “RSVP” in the IP header, i.e. in the header of an IP packet.

The routers identify this protocol type and relay messages characterized thus directly to their RSVP entities, i.e. to the control component AC.

Later, during the course of the procedure, the RSVP entity at the edge of the network in respect of the subscriber X must configure its edge router A (filtering, marking, policing). Specifically the interface, via which the RSVP message from the subscriber X originally arrived and via which the data stream from subscriber X to subscriber Y will later arrive, must be configured. As the RSVP entity is implemented in the router, it can request this internal information.

The solution to both points A and B here is the close internal link between network node and control component.
Re A) The resource requests reach the control component via specific filters in the network node or router, which identify the protocol ID and relay the packets past the routing directly to the internal control component.
Re B) The control component AC obtains information for configuring the network node or router by accessing internal router data.

With external control components there is the problem that this internal information is not requested from the network node or made available by the network node.

In the document “Implementation techniques of intserv/diffserv integrated network” by Minghai Xu et al., IEEE vol. 1, 9 Apr. 2003, improvements are disclosed for integrated services in the context of Intserv/Diffserv networks. To this end service level specifications (SLS) with flow diagrams and algorithms are proposed, with which defined DSCP values are provided for signaling messages. Limits are also discussed for delaying services in Diffserv networks.

In document WO 01/03383 a system and a method are disclosed for transmitting data in a communication system. This comprises a source network node, a packet data network, routers or switches and a destination network node. The source network node sends data packets, which contain information about the path or hop response, to a control network node. The control network node sends the data packets to a destination network node but with a different hop response from the one originally specified in the data packets. This different hop response was sent previously from the destination network node to the control network node.

### SUMMARY OF INVENTION

An object of the present invention is to specify a method, with which received IP packets can be relayed with interface information from the receiving network node to an external control component.

This object is achieved by a method according to the features of the claims.

The advantage of the invention is that IP packets with internal network node control information are relayed to an external control component. This means that a control component “added on” to a network node can take over more extensive control tasks from the network node.

Advantageous developments of the invention are specified in the dependent claims.

### BRIEF DESCRIPTION OF THE DRAWINGS

An exemplary embodiment of the invention is illustrated in the drawing and described below.

FIG. 1 shows a schematic IP network with internal network node control components AC according to the prior art,

FIG. 2 shows an IP network with the same structure as in FIG. 1 with external control components AC connected to the network node according to the invention.

### DETAILED DESCRIPTION OF INVENTION

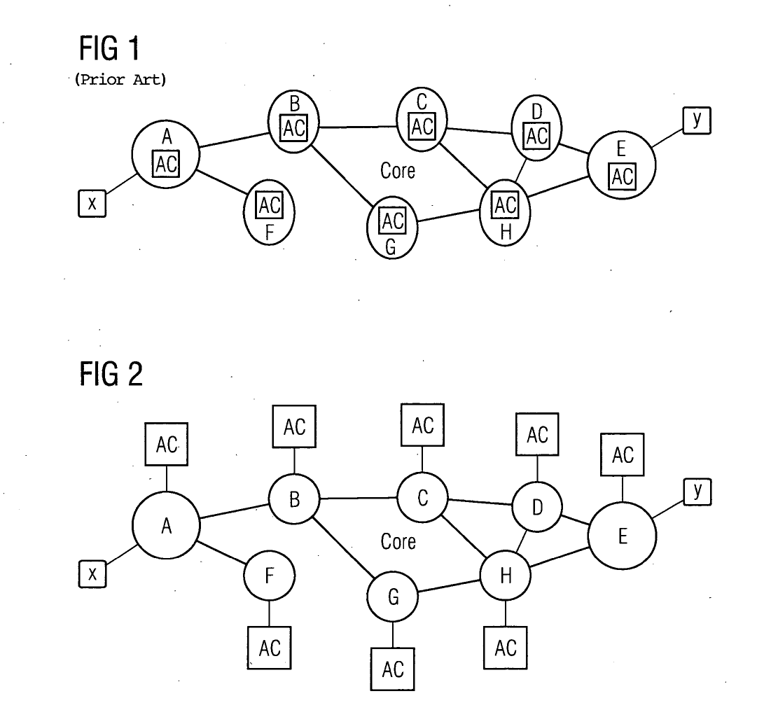

FIG. 1 shows an IP network according to the prior art as already described in the introductory part.

FIG. 2 shows a network according to FIG. 1 with the difference that an external control component AC is connected respectively to the network nodes A to H via a direct connection.

In the same way as in the example mentioned in the introductory part, data packets are to be transmitted from the subscriber X to the subscriber Y. The external control components AC thereby require defined IP packets such as the RSVP packets and information concerning the interface of the network node at which the IP packet/RSVP packet was received. The latter information is only available internally in the network node and cannot be requested. The routing tables of the network node or router only contain information about destinations, not about where a packet came from.

To resolve the problem, rules are first configured on the interfaces of the network nodes. Current network nodes or routers support so-called policy routing. Rules can thereby be configured about how to proceed with specific packets. In this instance the rule is:

“Packets with a defined protocol ID are not simply rerouted but are forwarded to a “next hop” as set in the rule, which leads to the competent external control entity.

According to the invention in-band IP signaling packets are output to an external interface of the network node, to which the external control component is linked.

Secondly in addition to the “next hop” the rules of policy routing also specify the value that a defined field of the header field of the IP packet should assume. For example the value that the so-called DSCP field in the IP header that comprises 6 bits should assume. In Diffserv networks this serves to characterize packet priority. If the control component or control entity is linked directly to the network nodes or routers via a specific interface, this DSCP information is however not required. Therefore a rule is configured on every input interface of the network node, to input or code a number or other information in a defined field of the header fields of the IP packet or the IP header, such as the DSCP field. This number is assigned uniquely to an interface, so that every interface respectively inputs a number or ID assigned to it in an IP packet, if the IP packet is intended for the external control component. This means for example that every in-band IP signaling packet, for example of the protocol type RSVP, is modified on the interface in the DSCP field, the number of the interface is for example input there and said packet is relayed to the external control component.

As the DSCP field in the header comprises 6 bits, it is possible to differentiate 64 values and therefore 64 interfaces of a network node.

The DSCP value can of course still be used to characterize packet priority in the network itself, as it can be set for example by the control component AC or control entity to a different value. Also, irrespective of “misuse” of the DSCP priority field, the packet can be processed in the relevant router itself with a selectable priority, as this can also be formulated in a router rule.

With a view to adding internal router information, such as interface numbers, virtual path identifier numbers or virtual channel identifier numbers, also referred to as VPI/VCI numbers, to the IP packets by means of rules in the router, it is possible to operate control components or control entities separately from the router.

1.-3. (canceled)

4. A method for relaying Internet Protocol (IP) packets to a control component assigned to a network node in a communication network, the communication network having a plurality of network nodes and switching IP packets, the method comprising:
receiving an in-band IP signalling packet at an interface of the network node;
identifying the packet based on a protocol field of a header in the packet;
inserting a value assigned to the receiving interface into a field of the header or an IP header in the packet, the value different than another value assigned to a non-receiving interface of the network node; and
routing the modified packet to the control component.

5. The method according to claim 4, wherein prior to routing the modified packet, the packet is identified as an RSVP type packet and the value of a DSCP field in the header of the packet is modified as a function of the receiving interface.

6. The method according to claim 5, wherein the DSCP field contains the value assigned to the receiving interface.
